(19) United States
(12) Patent Application Publication
(10) Pub. No.: US 2010/0038927 A1
(43) Pub. Date: Feb. 18, 2010

(54) Covering Flap of a Convertible

(75) Inventors: Fritz Wegener, Gilching (DE); Marco Carpenito, Torino (IT); Daniel Dragomir, Rosiori De Vede (RO)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Webasto AG, Stockdorf (DE)

(21) Appl. No.: 12/440,723

(22) PCT Filed: Sep. 25, 2007
(86) PCT No.: PCT/DE07/01726

§ 371 Date: Jul. 10, 2009

(30) Foreign Application Priority Data
Sep. 28, 2006 (DE) 102006046345.5

(51) Int. Cl. B60J 7/20; B60J 7/14

(52) U.S. Cl. 296/107.08

(57) ABSTRACT

The invention relates to a covering flap of a convertible, with a roof which is mounted movably on the vehicle body by means of roof kinematics and can be lowered into a rear storage compartment, wherein the covering flap is mounted pivotably and can be displaced between a covering position and a raised intermediate position by means of a displacement device coupled to the roof kinematics, and wherein the displacement device has a link mechanism with a component having a slotted guide and a component having an engagement part guided in the slotted guide, for the forced control of the displacement movement of the covering flap.

The invention relates to a covering flap of a convertible, with a roof which is mounted movably on the vehicle body by means of roof kinematics and can be lowered into a rear storage space, wherein the covering flap is mounted pivotably and can be displaced between a covering position and a raised intermediate position by means of a displacement device coupled to the roof kinematics.

The prior art discloses mechanisms for coupling the movement of the covering flap, which also serves in particular as a rear parcel shelf, to the movement of the roof kinematics, said mechanisms providing, in a complicated configuration, a dependency of the movement behavior of the covering flap on that of the roof kinematics.

DE 100 36 223 A1 has disclosed a vehicle with a displaceable roof and a rear parcel shelf which is mounted by means of a first link device and a second link device in a manner such that it is displaceable about two assigned, variable pivot axes such that said rear parcel shelf can be pivoted between its horizontal covering position and its raised open position, in order to expose a movement path of the roof which is to be opened or put away, and can be shifted horizontally. The first link device forms a continuous coupling of the movement of the rear parcel shelf to a main link, which is driven by an adjusting device, of roof kinematics movably supporting the roof. The second link device connects the adjusting device to the rear parcel shelf and, during actuation of the adjusting device, with stationary roof kinematics, brings about the pivoting of the rear parcel shelf into the covering position. The two displacement devices for the pivoting movement and the longitudinal movement are of comparatively complicated design because of the multiplicity of links required.

DE 102 17 916 A1 has disclosed a convertible with a roof which can be put away and with a rear parcel shelf which can be pivoted between its covering position and its open position about a pivot spindle mounted on the vehicle body. The rear parcel shelf is pivoted downward into its covering position exclusively by means of being coupled to a closing movement of a rear convertible top compartment cover.

EP 0 860 313 B1 has disclosed a rear parcel shelf of a convertible, which rear parcel shelf is mounted pivotably on a partition between the vehicle seats and the trunk and can be pivoted from its horizontal covering position within or below a rear roof part of the closed convertible roof into a vertical intermediate position on the rear side of the partition in order to open up a passage opening for putting away the roof into the storage compartment in the trunk. The pivoting movement of the rear parcel shelf is controlled by the pivoting movement of the trunk flap, which forms a convertible top compartment cover and can be raised at its front edge for the putting away of the roof, with a Bowden cable forming a direct connection between the trunk flap and the rear parcel shelf which is prestressed into the storage position by a spring.

The invention is based on the object of providing a covering flap which is mentioned at the beginning and has a simply designed and operationally reliable displacement device.

According to the invention, the object is achieved in the case of the abovementioned covering flap in that the displacement device has a link mechanism with a component having a slotted guide, and with a component having an engagement part guided in the slotted guide, for the forced control of the displacement movement of the covering flap.

Advantageous refinements of the invention are specified in the dependent claims.

The displacement device according to the invention for the covering flap, which in particular constitutes a rear parcel shelf, forms a direct driving connection between the roof kinematics and the covering flap, with forced control by means of a kinematic chain formed by the mechanism or link parts. There is no driving connection to a convertible top compartment cover or trunk cover. The displacement device forms a simple kinematic chain without branching and without spring devices inserted into the course of the force. Said displacement device is therefore simple, cost-effective to produce and operationally reliable.

Synchronization of the movements of the roof kinematics and of the movement of the covering flap is achieved in a simple manner by the displacement device. The curved profile of the slotted guide, which in general constitutes a forced guide for the engagement part, can be selected as necessary such that an optimum movement sequence is set. The slotted guide is understood as being any shape of guide for a part guided or controlled thereon.

In comparison to a displacement device with flexible and in particular temperature-dependent components, said displacement by means of the forced control with inherently rigid components is unaffected by temperature fluctuations.

The slotted guide, by means of a gentle curve profile, enables the displacement device to move without jolting. Even if the vehicle is parked on a slope, in comparison to flexible displacement devices there are no effects on the movement behavior of the displacement device or of the covering flap in synchronism with the roof kinematics.

The link mechanism is understood as meaning any connection for the transmission of movement to rigid components, such as, for example, links, levers, windows or the like.

Particular preference is given to a design, in which the displacement device contains a first link which is coupled to the roof kinematics, such as, for example, a main link, a plate cam which contains the slotted guide and is mounted pivotably on the vehicle body, a pivoting link which contains the engagement part guided in the slotted guide and in particular is mounted pivotably on the vehicle body, and a second link which transmits the displacement movement to the covering flap or to a bearing lever of the covering flap.

A covering flap according to the invention is explained in more detail below using an exemplary embodiment and with reference to the drawing, in which:

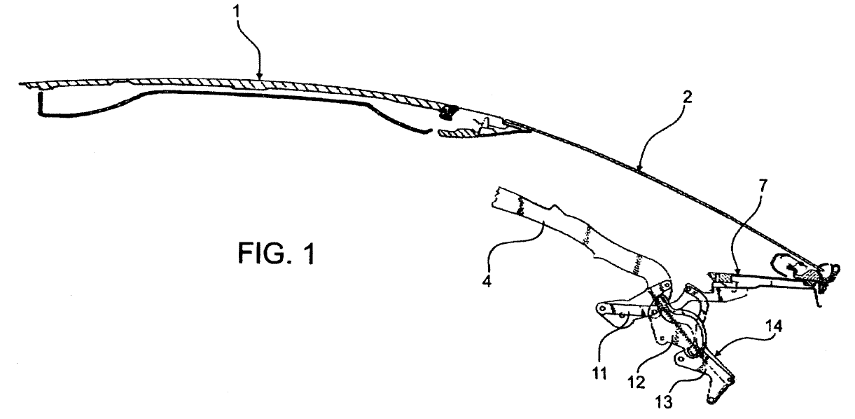

FIG. 1 shows, in a side view, a hard top vehicle roof, which can be put away, of a convertible in the closed position, and also a covering flap in the covering position below the rear roof part;

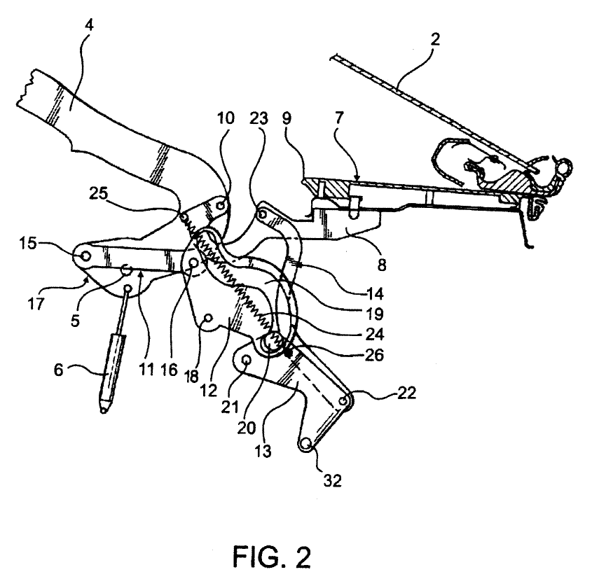

FIG. 2 shows, in a side view on an enlarged scale, the covering flap of FIG. 1 with a displacement device;

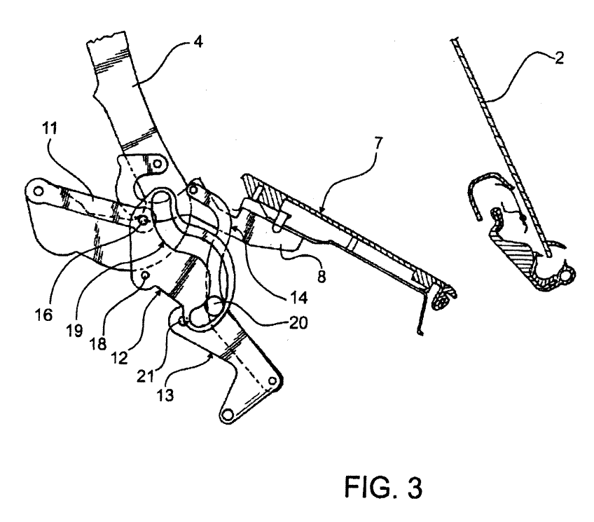

FIG. 3 shows, in a side view on an enlarged scale, the covering flap which, as the roof is being put away, is lowered by the displacement device into a first intermediate position;

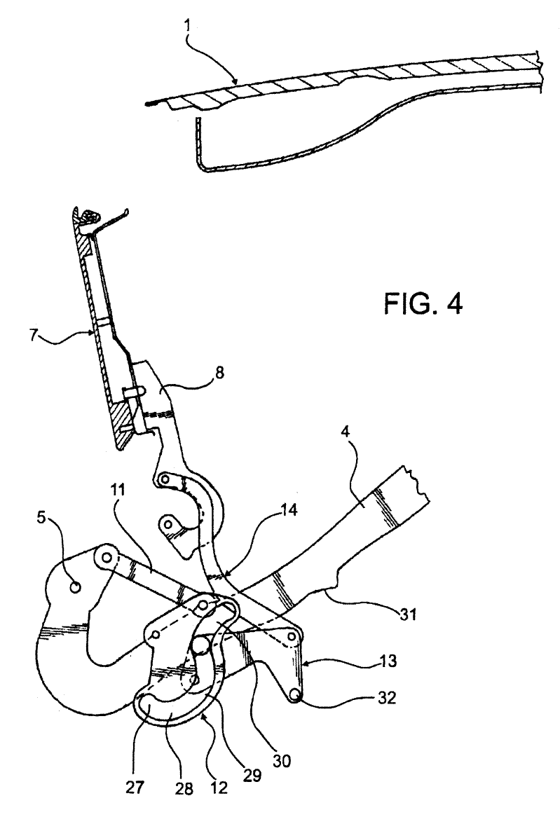

FIG. 4 shows, in a side view on an enlarged scale, the covering flap which, as the roof continues to be put away, is raised by the displacement device into a second intermediate position;

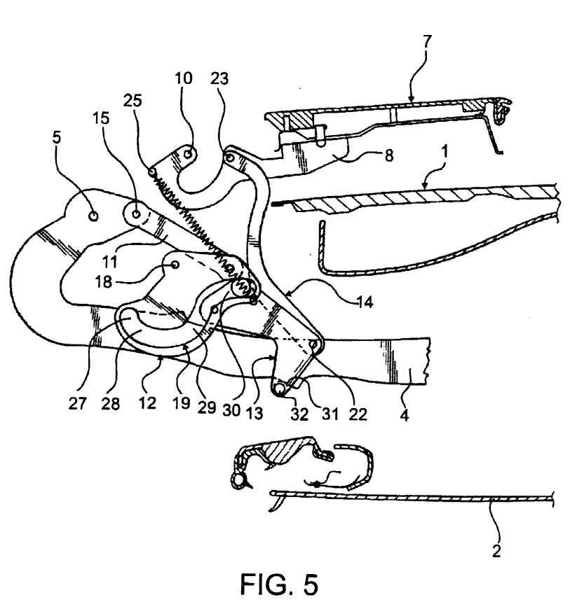

FIG. 5 shows, in a side view on an enlarged scale, the covering flap which, when the roof is put away into a storage space of the convertible, is pivoted back by the displacement device into a covering position; and

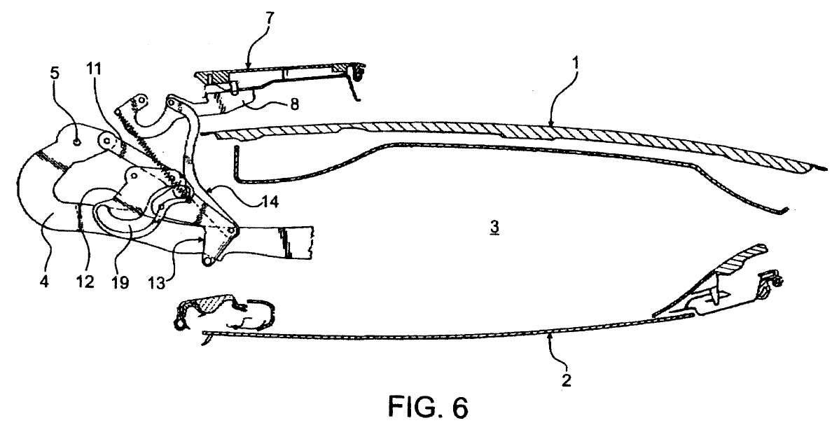

FIG. 6 shows, in a side view, the roof which is put away into the storage space of the convertible, with the covering flap pivoted back into the covering position according to FIG. 5.

A hard top roof (illustrated schematically in the figures) of a vehicle (not illustrated) contains a front roof part 1 and a rear roof part 2 which can be displaced between a closed position (FIG. 1) over the vehicle interior and an open or storage position in which they are put away in a rear storage space or convertible top compartment 3 of the convertible. A roof of this type is basically known from DE 102 17 916 B4. The roof is constructed substantially symmetrically with respect to the longitudinal axis of the vehicle, and therefore the following description refers to the components on one of the two sides.

The roof is mounted movably on the vehicle body by means of a bearing device or roof kinematics in the form, for example, of a four-bar linkage which has a main link 4 and a main pillar (not illustrated). The main link 4 is mounted pivotably about a transverse axis in a pivot bearing 5 on the vehicle body and can be pivoted in a known manner by a driving device 6, for example a hydraulic cylinder unit which is preferably connected to the main link via an intermediate mechanism.

According to the exemplary embodiment illustrated, the roof is a movable hard top, but can alternatively also be a folding top or flexible soft top with a foldable convertible top linkage. The roof part 2, which is at the rear in the closed position of the roof, or the C segment, which in particular contains a rear window, is adjoined by a trunk flap (not illustrated) which is mounted pivotably about a front pivot spindle by means of a pivot bearing device, and can be raised at its rear edge in order to release a loading opening for loading and unloading the trunk.

The trunk flap, which also covers, for example, the storage space or convertible top compartment 3 which takes up part of the trunk, is mounted pivotably about a rear pivot spindle by means of a rear bearing device and is raised at its front edge about said pivot spindle in order to release a passage opening for the roof such that the roof can be put away into the convertible top compartment 3 or can be removed therefrom. During the putting-away of the, for example, two-part hard top roof, the front roof part 1, for example, pivots convexly onto the rear roof part 2 and all of the roof parts drop into the convertible top compartment 3 (see FIG. 6).

When the roof is closed and also when it is put away, a covering flap 7, which can also be referred to as the rear parcel shelf (see FIG. 1, not illustrated in FIG. 2), extends in front of the trunk flap substantially horizontally over a region through which the roof moves into the convertible top compartment 3 and out therefrom during the opening and closing operations.

The covering flap 7 is attached on both sides to a respective bearing lever 8 which is mounted pivotably about a pivot spindle 10, which is mounted on the vehicle body and is positionally fixed, for example, on the main bearing 7, in front of the front edge 9 of the covering flap 7, with respect to the covering position of the covering flap 7 according to FIG. 2, such that, when the roof is closed and also when it is put away (FIGS. 1 and 2 and also 5 and 6), the covering flap 7 can be pivoted between its, for example, substantially horizontal covering position, a lowered first intermediate position (FIG. 3) and a raised second intermediate position (FIG. 4).

A displacement device of the covering flap 7 contains a first link 11, a plate cam 12, a pivoting link 13 and a second link 14. The first link 11 is coupled movably by a joint 15 to the main link 4 and by a joint 16 to the plate cam 12. The joint 15 is located on a projection 17 of the main link 4 at a distance from the pivot bearing 5 thereof (to the left in the direction of travel according to FIG. 2 when the roof is closed).

The plate cam 12 is mounted pivotably about a pivot spindle 18 mounted on the vehicle body. In the position according to FIG. 2, the joint 16 is spaced apart from the pivot spindle 18 and is arranged thereabove. The plate cam 12 contains a control curve, for example running in an approximately S-shaped manner, or a slotted guide 19 in which an engagement part 20, which is attached to the pivoting link 13, is displaceably accommodated. The engagement part 20, for example a pin, a roller or a sleeve, is guided in a play-free or substantially play-free manner in the slotted guide 19 and is arranged at a distance from a pivot spindle 21 of the pivoting link 13, which pivot spindle is preferably mounted on the vehicle body, and therefore a movement of the engagement part 20 about the pivot spindle 21 pivots the pivoting link 13.

The second link 14 is coupled to the pivoting link 13 in a joint 22 and to the bearing lever 8 of the covering flap 7 in a joint 23, wherein the joint 22 is significantly spaced apart from the pivot spindle 21 and the engagement part 20, and the joint 23 is spaced apart from the pivot spindle 10 and is arranged, for example, between the pivot spindle 10 and the covering flap 7.

A tensioning device for pretensioning the covering flap 7 in a pivoting direction contains, for example, a tension spring 24 which is fastened at a bearing 25 to the bearing lever 8 and to a fixing point 26 on the vehicle body.

When the roof is closed (FIGS. 1 and 2), the covering flap 7 is arranged in its substantially horizontal or else somewhat inclined covering position under the rear roof part 2. The engagement part 20 is arranged at the lower end 27 (with regard to FIG. 2) of the slotted guide 19. The tension spring 24 tensions the covering flap 7 upward counter to the weight thereof and therefore forms a means of relieving weight. The tension spring 24 also ensures that a possible play in the displacement device and in particular between the engagement part 20 and the slotted guide 19 is compensated for by play being eliminated via the bearing lever 8, the second link 14 and the pivoting link 13.

Before the roof is opened, the trunk flap is first of all pivoted up to the rear in order to expose the putting-away path for the roof. The main link 4 is then pivoted by means of the driving device in the opening direction (in the clockwise direction in FIGS. 1 and 2). The pivoting main link 4 moves the plate cam 12 via the first link 11 in the clockwise direction too, such that the slotted guide 19 thereof, on account of its initial curve profile (the path of the slotted guide 19 initially distances itself from the pivot spindle 21 in one region 28 of the slotted guide 19), displaces the engagement part 20 to the right in FIG. 2. The pivoting link 13 therefore pivots in the clockwise direction and pulls the bearing arm 8 downward via the second link 14 such that the covering flap 7 takes up the first intermediate position in which it is pivoted downward (illustrated in FIG. 3) and opens up the path of movement to the rear roof part 2 for dropping into the convertible top compartment 3.

During the further course of the movement of the pivoting main link 4 (FIG. 3 to FIG. 4), the slotted guide 19, on account of its path profile (region 29 of the slotted guide 19) approaching the pivot spindle 18 of the plate cam 12, guides the engagement part 20 toward the pivot spindle 18, as a result of which said engagement part pivots the pivoting link 13 back anticlockwise. In the process, the second link 14 which is coupled thereto pivots the bearing arm 8 and therefore the covering flap 7 upward into a second intermediate position or maximum opening position such that the path is opened up for putting away the front roof part 1.

During further pivoting of the main link 4 by means of the driving device 6 into a position in which the roof is completely put away (movement from FIG. 4 to FIGS. 5 and 6), the engagement part 20 follows the slotted guide 19, the path profile of which (region 30 of the slotted guide) moves away again from the pivot spindle 18 of the plate cam 12 in a manner such that it is at a distance from the pivot spindle 18 and pivots back the pivoting link 13 again in the clockwise direction. Via the second link 14, which is coupled thereto, the bearing lever 8 and therefore the covering flap 7 are pivoted into their covering position when the roof has been put away. Said covering position can coincide with the covering position when the roof is closed, or else can differ therefrom, with the covering position being determined by the current position of the engagement part 20 and, in association therewith, by the shape and the position of the slotted guide 19 and being able to be configured as required.

In its upper end region 30, the slotted guide 19 approximates a radial profile with respect to the pivot spindle 18. As a result, the adjusting force of the slotted guide 19 on the engagement part 20 is reduced. The main link 4 has a stop surface 31 which comes into engagement with an engagement part 32, for example a pin, a roller or a sleeve, attached to the pivoting link 13 when said engagement part moves into its end pivoting position. The main link 4 therefore assists the movement of the engagement part 20 in the slotted guide 19 and at the same time the pivoting movement of the covering flap 7 into its covering position in which it is secured against inadvertent opening. When the engagement part 20 bears against the end of the slotted guide 19, the covering flap 7 is also mechanically blocked against being pressed down.

In order to finish the operation to put away the roof, the trunk flap is closed such that it adjoins the covering flap 7 preferably in a flush manner.

In order to close the roof put away in the convertible top compartment 3, the trunk flap is first of all raised on the front side and the described movement sequence now takes place in reverse.

Of course, the main pillar can also be pivoted by the driving device 6, and the main link 4 is pivoted at the same time during the movement of the four-bar linkage.

The illustrated shapes of the components of the displacement device are examples and can be varied for adaptation to the function.

The first region 28 of the slotted guide 19, in which the latter is at a distance from the pivot spindle 18, can also be omitted or formed as a circular arc which is concentric with respect to the pivot spindle 18, if the dropping of the covering flap 7 into an intermediate position shall not be required.

At least two components of the displacement device can be arranged in a self-locking position, for example in the storage position of the roof, such that an undesirable displacement, applied from the outside, of the covering flap is prevented.

### LIST OF REFERENCE NUMBERS

| | |
|---|---|
| 1 | Front roof part |
| 2 | Rear roof part |
| 3 | Convertible top compartment |
| 4 | Main link |
| 5 | Pivot bearing |
| 6 | Driving device |
| 7 | Covering flap |
| 8 | Bearing lever |
| 9 | Front edge |
| 10 | Pivot spindle |
| 11 | First link |
| 12 | Plate cam |
| 13 | Pivoting link |
| 14 | Second link |
| 15 | Joint |
| 16 | Joint |
| 17 | Projection |
| 18 | Pivot spindle |
| 19 | Slotted guide |
| 20 | Engagement part |
| 21 | Pivot spindle |
| 22 | Joint |
| 23 | Joint |
| 24 | Tension spring |
| 25 | Bearing |
| 26 | Fixing point |
| 27 | Lower end |
| 28 | Region |
| 29 | Region |
| 30 | Region |
| 31 | Stop surface |
| 32 | Engagement part |

1. A covering flap of a convertible vehicle, with a roof movably mounted on a vehicle body by roof kinematics and which can be lowered into a rear storage space, wherein the covering flap is pivotably mounted and can be displaced between a covering position and a raised intermediate position by a displacement device coupled to the roof kinematics, wherein the displacement device has a link mechanism with a component having a slotted guide, and a component having an engagement part guided in the slotted guide, for the forced control of the displacement movement of the covering flap.

2. The covering flap as claimed in claim 1, wherein the component having the slotted guide is a driven pivoting component which, via its pivoting movement and its slotted-guide movement, carries out the displacement movement of the component having the engagement part.

3. The covering flap as claimed in claim 1, wherein the slotted guide has at least one portion in which the engagement part is assigned to a raising movement of the covering flap.

4. The covering flap as claimed in, claim 1, wherein the slotted guide has at least one portion in which the engagement part is assigned to a lowering movement of the covering flap into its covering position.

5. The covering flap as claimed in claim 1, wherein the slotted guide has a portion in which the engagement part is assigned to an initial lowering movement of the covering flap as the roof is being put away from its closed position.

6. The covering flap as claimed in claim 1, comprising a tensioning device pretensioning the covering flap in a weight-relieving manner.

7. The covering flap as claimed in claim 1, wherein the displacement device contains a first link which is coupled to the roof kinematics, a plate cam which contains the slotted guide and is pivotably mounted on the vehicle body, a pivoting link which contains the engagement part guided in the slotted guide, and a second link which transmits the displacement movement to the covering flap or to a bearing lever of the covering flap.

8. The covering flap as claimed in claim 7, comprising a tensioning device, the tensioning device pretensioning the covering flap in a weight-relieving manner.

9. The covering flap as claimed in claim 1, wherein at least two components of the displacement device are arranged in a self-locking manner with respect to each other in an end position.

10. The covering flap as claimed in claim 1, comprising an engagement part provided on the displacement device, via which engagement part the roof kinematics or a main link applies a closing force to the displacement device or the covering flap in the storage position of the roof.

11. A vehicle with a covering flap as claimed claim 1.

12. The vehicle as claimed in claim 11, wherein the vehicle has a single- or multi-part hard top roof or a soft top roof.

13. The vehicle as claimed in claim 6, wherein the tensioning device is a tension spring.

14. The covering flap as claimed in claim 1, wherein the displacement device contains a first link which is coupled to the roof kinematics, a plate cam which contains the slotted guide and is pivotably mounted on the vehicle body, a pivoting link which contains the engagement part guided in the slotted guide and is pivotably mounted on the vehicle body, and a second link which transmits the displacement movement to the covering flap or to a bearing lever of the covering flap.

15. The vehicle as claimed in claim 8, wherein the tensioning device is a tension spring.
